(19) United States
(12) Patent Application Publication
(10) Pub. No.: US 2003/0002205 A1
(43) Pub. Date: Jan. 2, 2003

(54) Flexible disk drive with a heat release structure for releasing self heat generated from an electronic component mounted thereto

(75) Inventors: Akira Shibata, Murayama-shi (JP); Yoshihito Otomo, Tendo-shi (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: Mitsumi Electric Co. Ltd., Tokyo (JP)

(21) Appl. No.: 10/179,871

(22) Filed: Jun. 25, 2002

(30) Foreign Application Priority Data
Jun. 27, 2001 (JP) 194546/2001

(51) Int. Cl. G11B 17/00

(52) U.S. Cl. 360/97.01

(57) ABSTRACT

In a flexible disk drive with a heat release structure for driving a flexible disk, a mechanical structure is adapted to receive the flexible disk. The flexible disk drive is provided with a holding member holding a space between the mechanical structure and a main printed wiring board which is mounted on the mechanical structure and on which an electronic component mounted. The main printed wiring board includes a signal pattern connected to a conductive signal terminal of the electronic component, a first ground pattern connected to a conductive ground terminal of the electronic component, and a second ground pattern connected to the first ground pattern. The second ground pattern is connected to the mechanical structure through the holding member.

### BACKGROUND OF THE INVENTION

This invention relates to a flexible disk drive with an electronic component mounted thereto and, in particular, to a flexible disk drive having a heat release structure for releasing self heat generated from an electronic component mounted thereto.

As well known, a flexible disk drive (FDD) is an apparatus for carrying out data recording and reproducing operations to and from a disk-shaped magnetic recording medium contained in a flexible disk (FD). The flexible disk drive is mounted in an apparatus such as a personal computer, a work station, and a word processor.

The flexible disk is inserted into the flexible disk drive. The flexible disk inserted into the flexible disk drive is held on a disk table having a rotation shaft in the manner such that the center of the flexible disk is coincident with the rotation shaft of the disk table. The disk table is rotatably supported on a principal surface of a main frame.

The disk table is driven and rotated by a spindle motor or a DD (direct drive) motor mounted on a back surface of the main frame. The magnetic recording medium contained in the flexible disk is rotated by the rotation of the disk table. To the back surface of the main frame, a main printed wiring board with a number of electronic components mounted thereon is attached. Those electronic components require a large electric current so that self heat of a large quantity is generated. The self heat generated from the electronic components may adversely affect the operation or the function of the flexible disk drive and, therefore, must be released by the use of a heat release structure.

In an existing flexible disk drive with a heat release structure, each of the electronic components mounted on the main printed wiring board is covered with an iron cover (i.e., a heat release plate) through a heat release member. With this heat release structure, the self heat generated from the electronic component is transferred and released through the heat release member to the iron cover.

However, in the existing flexible disk drive with a heat release structure mentioned above, additional elements, such as the heat release member and the iron cover, are required in order to release the self heat generated from the electronic component. As a consequence, the number of elements of the flexible disk drive is inevitably increased.

Upon assembling the existing flexible disk drive with a heat release structure, the heat release member is formed on the electronic component after the electronic component is mounted on the main printed wiring board. Thereafter, the iron cover is arranged on the electronic component through the heat release member. Thus, assembling is inevitably complicated.

### SUMMARY OF THE INVENTION

It is therefore an object of this invention to provide a flexible disk drive with a heat release structure for an electronic component, which is reduced in number of elements and which is easily assembled.

Other objects of the present invention will become clear as the description proceeds.

According to this invention, there is provided a flexible disk drive with a heat release structure for driving a flexible disk. The flexible disk drive comprises a mechanical structure for receiving the flexible disk, a main printed wiring board mounted on the mechanical structure, a holding member holding a space between the main printed wiring board and the mechanical structure, and an electronic component mounted on the main printed wiring board. The electronic component comprises an electronic component body, a conductive signal terminal extending outward from the electronic component body, and a conductive ground terminal extending outward from the electronic component body. The main printed wiring board includes a signal pattern connected to the conductive signal terminal, a first ground pattern connected to the conductive ground terminal; and a second ground pattern connected to the first ground pattern and to the mechanical structure through the holding member.

### BRIEF DESCRIPTION OF THE DRAWINGS

FIG. 1 is an exploded perspective view of an existing flexible disk drive;

FIG. 2 is a perspective view of the flexible disk drive illustrated in FIG. 1 in an assembled state;

FIG. 3 is a side view showing a heat release structure in the existing flexible disk drive illustrated in FIG. 1;

FIG. 4 is a plan view showing the electronic component illustrated in FIG. 3;

FIG. 5 is a perspective view for describing a flexible disk drive with a heat release structure according to one embodiment of this invention;

FIG. 6 is a side view showing the heat release structure of the flexible disk drive illustrated in FIG. 5; and

FIG. 7 is a plan view of the heat release structure illustrated in FIG. 6.

### DESCRIPTION OF THE PREFERRED EMBODIMENTS

In order to facilitate an understanding of this invention, an existing flexible disk drive will at first be described in detail.

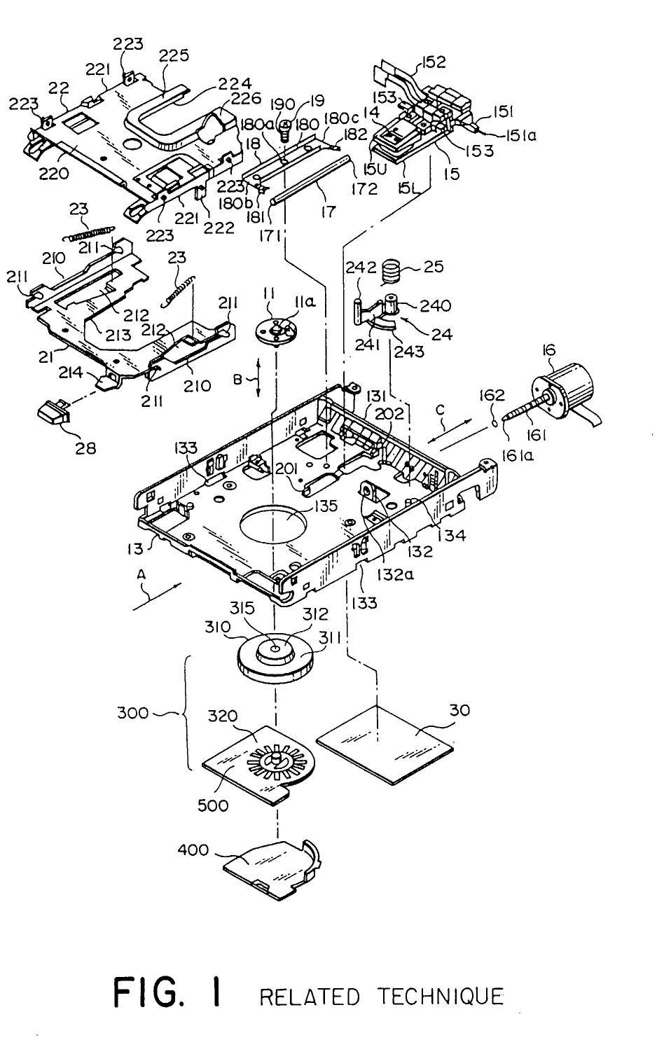

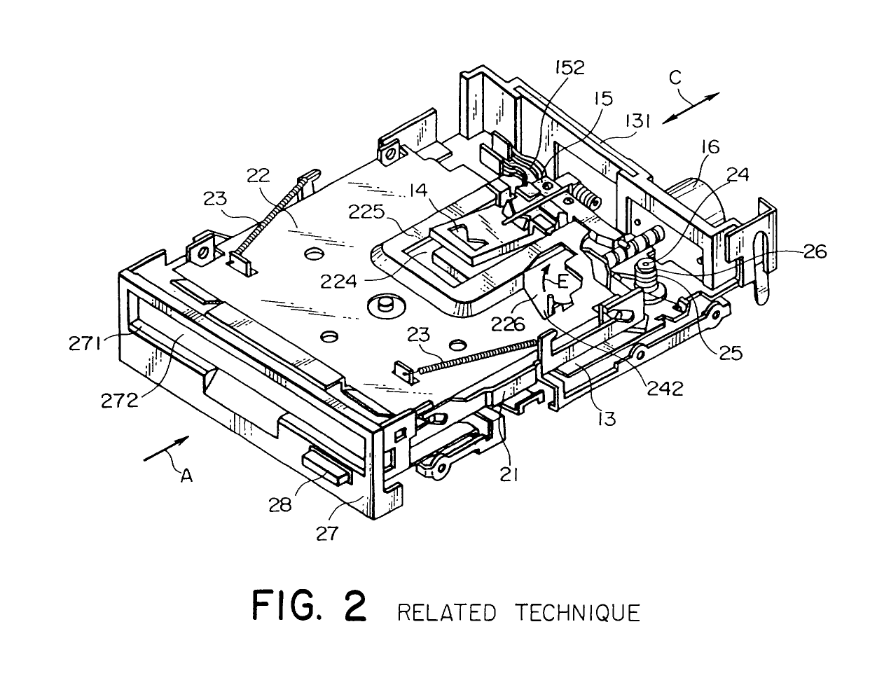

Referring to FIGS. 1 and 2, an existing flexible disk drive of a 3.5-inch type is shown. In FIG. 1, a front panel and a case are omitted for convenience of illustration. In FIG. 2, the case is omitted.

The flexible disk drive is a device for driving a flexible disk of a 3.5-inch type (not shown). The flexible disk is loaded or inserted into the flexible disk drive in an inserting direction depicted by an arrow A in FIGS. 1 and 2. The flexible disk thus inserted is held on a disk table 11 having a rotation shaft 11a in the manner such that the center of the flexible disk is coincident with the rotation shaft 11a. As will later be described, the disk table 11 is rotatably supported on a principal surface 13f of a main frame 13.

Therefore, the rotation shaft 11a of the disk table 11 has an axial direction B parallel to a thickness direction of the main frame 13. The disk table 11 is driven and rotated by a spindle motor or a DD (direct drive) motor 300 mounted on a back surface of the main frame 13 opposite to the principal surface 13f. The flexible disk contains a magnetic recording medium which is rotated by the rotation of the disk table 11. To the back surface of the main frame 13, a main printed wiring board 30 is attached. The main printed wiring board 30 is provided with a number of electronic components mounted thereon.

The flexible disk drive comprises a pair of upper and lower magnetic heads 14 (only the upper magnetic head is illustrated in the figure) for reading/writing data from/to the magnetic recording medium in the flexible disk. The magnetic heads 14 are supported by a carriage assembly 15 at its end. The carriage assembly 15 comprises an upper carriage 15U supporting the upper magnetic head 14 and a lower carriage 15L supporting the lower magnetic head 14. The carriage assembly 15 is disposed above the principal surface 13f of the main frame 13 and spaced from the main frame 13 as will later be described. The carriage assembly 15 supports the magnetic heads 14 at its end so that the magnetic heads 14 are movable in a predetermined radial direction C with respect to the flexible disk.

The main frame 13 has a side wall 131 standing from the principal surface 13f. To the side wall 131, a stepping motor 16 is fixed. The stepping motor 16 serves to linearly drive the carriage assembly 15 in the predetermined radial direction C. More in detail, the stepping motor 16 has a rotation shaft (driving shaft) 161 extending in parallel to the predetermined radial direction C. The rotation shaft 161 is provided with a male thread. The rotation shaft 16 has a forward end 161a inserted into a hole 132a formed in a bent portion 132 standing from the principal surface 13f of the main frame 13. The bent portion 132 is formed by cutting and bending a portion of the main frame 13. The forward end 161a of the rotation shaft 161 is provided with a steel ball 162. By the hole 132a and the steel ball 162, the rotation shaft 161 is defined in its position to extend in parallel to the predetermined radial direction C and the forward end 161a is rotatably held.

On the other hand, the carriage assembly 15 comprises an arm 151 extending from the lower carriage 15L to the rotation shaft 161. The arm 151 has a forward end 151a to be engaged with a root of the male thread of the rotation shaft 161. Therefore, when the rotation shaft 161 of the stepping motor 16 is rotated, the forward end 151 a of the arm 151 is moved along the root of the male thread of the rotation shaft 161 so that the carriage assembly 15 itself is moved along the predetermined radial direction C. Thus, the stepping motor 16 serves as a driving arrangement for linearly moving the carriage assembly 15 in the predetermined radial direction C.

The rotation shaft 161 of the stepping motor 16 is disposed on one side of the carriage assembly 15. Therefore, the one side of the carriage assembly 15 is movably supported by the rotation shaft 161 and spaced from the principal surface 13f of the main frame 13. However, by the rotation shaft 161 alone, it is impossible to support a whole of the carriage assembly 15 with a space kept from the principal surface 13f of the main frame 13. Therefore, the carriage assembly 15 is supported and guided by a guide bar 17 on the other side of the carriage assembly 15.

The guide bar 17 is arranged on the other side of the carriage assembly 15 opposite to the rotation shaft 161 of the stepping motor 16. The guide bar 17 extends in parallel to the predetermined radial direction C and has one end 171 and the other end 172 fixedly mounted on the principal surface 13f of the main frame 13. The guide bar 17 serves to guide the carriage assembly 15 in the predetermined radial direction C. Thus, the carriage assembly 15 as a whole is supported with a space from the principal surface 13f of the main frame 13.

A flexible printed circuit (FPC) 152 extends from the carriage assembly 15 towards the guide bar 17. The FPC 152 is electrically connected to the main printed wiring board 30 attached to the back surface of the main frame 13.

The guide bar 17 is clamped on the principal surface 13f of the main frame 13 by a guide bar clamp 18. The guide bar clamp 18 is fixed at its center to the principal surface 13f of the main frame 13 by a binding screw 19. More in detail, the guide bar clamp 18 comprises a rectangular fixing member 180 slightly longer than the guide bar 17. The rectangular fixing member 180 is provided with a hole 180a formed at its approximate center and having a size allowing a screw shaft 190 of the binding screw 19 to pass therethrough. The rectangular fixing member 180 has one end 180b and the other end 180c from which a pair of arms 181 and 182 extend outward to clamp the one end 171 and the other end 172 of the guide bar 17, respectively.

The guide bar clamp 18 merely clamps the guide bar 17. By the guide bar clamp 18 alone, the guide bar 17 can not be fixed to the principal surface 13f of the main frame 13. Therefore, a pair of positioning members are required to position the one end 171 and the other end 172 of the guide bar 17. As the positioning members, a pair of bent portions 201 and 202 are used. Each of the bent portions 201 and 202 is formed by cutting a portion of the main frame 13 and bending the portion on the side of the back surface of the main frame 13.

The lower carriage 15L of the carriage assembly 15 also serves as a supporting frame supporting the carriage assembly 15 in the manner such that the carriage assembly 15 is slidable along the guide bar 17. The lower carriage 15L has a protruding portion (not shown) protruding on the side of the guide bar 17. The guide bar 17 is slidably fitted to the protruding portion.

The flexible disk drive further comprises an eject plate 21 and a disk holder 22. Each of the main frame 13, the eject plate 21, and the disk holder 22 is formed by punching, pressing, and bending a metal plate.

The eject plate 21 is mounted on the principal surface 13f of the main frame 13 to be slidable in the inserting direction A of the flexible disk and an ejecting direction opposite thereto. As will later be described, the eject plate 21 holds the flexible disk in cooperation with the disk holder 22 during operation of the flexible disk drive. In order to allow the flexible disk to be inserted into the flexible disk drive in the inserting direction A and to eject the flexible disk from the flexible disk drive in the ejecting direction opposite thereto, the eject plate 21 holds the flexible disk in the manner such that the flexible disk is slidable in the inserting direction A. The eject plate 21 is provided with a pair of side walls 210 faced to each other. Each of the side walls 210 is provided with a pair of cam portions 211. The eject plate 21 has a bottom wall provided with a pair of cutout portions 212 formed along the side walls 210, respectively, and a generally U-shaped opening 213 formed at a center area of the bottom wall to surround the disk table 11. The eject plate 21 is provided with a pin (not shown) formed on its lower surface. The pin is engaged with a locking part of an eject lever which will later be described.

The disk holder 22 is disposed on the eject plate 21. The disk holder 22 has a principal surface 220 and a pair of side walls 221 formed on opposite sides of the principal surface 220 and faced to each other. The side walls 221 respectively have protrusions 222 (only one being illustrated in the figure). The protrusions 222 are inserted into bores 133 formed in the main frame 13 through the cutout portions 212 of the eject plate 21. By inserting the protrusions 222 into the bores 133 of the main frame 13, the disk holder 22 is positioned with respect to the main frame 13 in the inserting direction A and is reciprocally movable in the axial direction B of the rotation shaft 11 a of the disk table 11. Each of the both side walls 221 has a pair of pins 223. The pins 223 are inserted in the cam portions 211 formed in the side walls 210 of the eject plate 21. Between the disk holder 22 and the eject plate 21, eject springs 23 are bridged.

In the illustrated example, the disk holder 22 is provided with the protrusions 222 while the main frame 13 is provided with the bores 133. Alternatively, the main frame may be provided with protrusions while the disk holder is provided with bores.

The disk holder 22 has a generally rectangular opening 224 formed in a center area inward in the insertion direction A. Specifically, the opening 224 is formed at a position corresponding to the upper carriage 15U of the carriage assembly 15 and extends in the predetermined radial direction C. The opening 224 is surrounded by a generally U-shaped ridge 225 rising upward from the principal surface 220 of the disk holder 22. On the other hand, the carriage assembly 15 comprises a pair of side arms 153 extending in a lateral direction. The side arms 153 are located on or above the ridge 225. As will later be described, in the state where the flexible disk is ejected from the disk holder 22, the side arms 153 are engaged with the ridge 225 so that the upper and the lower magnetic heads 14 are separated from each other. Furthermore, the disk holder 22 has an additional opening 226 formed at a right-hand side of the opening 224 inward in the insertion direction A. The opening 226 has a shape such allowing the rotation of a lever part of the eject lever which will later be described.

In the vicinity of the carriage assembly 15, the eject lever 24 is formed on the main frame 13 to be rotatable. More specifically, on the main frame 13, a rod pin 134 stands up from the principal surface 13f and extends upward. The eject lever 24 comprises a cylindrical part 240 in which the rod pin 134 is fitted, an arm part (lever part) 241 extending from the cylindrical part 240 in a radial direction, a projecting part 242 formed at a free end of the arm part 241 and extending upward, and an arc-shaped locking part 243 extending from the side of the free end of the arm part 241 in a circumferential direction. The eject lever 24 is provided with an eject lever spring 25 attached around the cylindrical part 240. The eject lever spring 25 urges the eject lever 24 in a counterclockwise direction in the figure (reverse to an arrow E illustrated in FIG. 2). The projecting part 242 of the eject ever 24 is loosely fitted to the opening 226 of the disk holder 22. The projecting part 242 is engaged with a predetermined position of a shutter of the flexible disk to controllably open and close the shutter. A screw 26 is engaged with an end of the rod pin 134 so as to prevent the eject lever 24 from being released from the rod pin 134.

The main frame 13 has a front end portion provided with a front panel 27 attached thereto. The front panel 27 has an opening 271 allowing passage of the flexible disk and a shutter or door 272 for closing the opening 271. The front panel 27 is provided with an eject button 28 protruding therefrom to be movable backward and forward. The eject button 28 is fitted to a protruding part 214 protruding forward at a front end of the eject plate 21.

The DD motor 300 comprises a rotor 310 and a stator 320 combined with the rotor 310. The rotor 310 comprises a disk-shaped metal casing 311 and a protruding portion 312 formed at its center. The protruding portion 312 has a generally trapezoidal section. The disk table 11 is fixedly attached to an upper surface of the protruding portion 312. The main frame 13 is provided with a circular opening 315 which allows only an upper part of the protruding portion 312 to pass therethrough and protrude on the principal surface 13f of the main frame 13. As a consequence, the disk table 11 protrudes on the principal surface 13f of the main frame 13.

The flexible disk received in the flexible disk drive is mounted on the disk table 11. A drive roller (not shown) is fitted into a hole formed in a hub (not shown) of the flexible disk so that the magnetic recording medium is driven and rotated.

On the other hand, the stator 320 is attached to the back surface of the main frame 13 by a motor frame 400. Specifically, the stator 320 is formed on a printed wiring board 500 mounted on a principal surface of the motor frame 400 made of metal.

On the printed wiring board 500, a frequency generating pattern FGPT is formed around the stator 320 of the DD motor. In other words, the frequency generating pattern FGPT is faced to a motor-servo magnetized portion (detection magnetized portion) of a permanent magnet (not shown) with a predetermined distance left therebetween.

When the motor-servo magnetized portion of the permanent magnet rotates above the frequency generating pattern FGPT, a counterelectromotive force is generated in the frequency generating pattern FGPT. It is noted here that the motor-servo magnetized portion of the permanent magnet has 120 poles along the circumference of the permanent magnet. Therefore, a single rotation of the DD motor results in generation of a 60-cycle signal from the frequency generating pattern FGPT. If the rotation speed of the DD motor is equal to 300 rpm, the DD motor performs five revolutions per second. In this case, an FG servo signal has a frequency of 300 Hz=(60×5).

Therefore, by comparing the FG servo signal and a frequency-division clock signal having a frequency-division clock frequency of 300 Hz which is obtained by frequency-dividing a reference clock signal having a reference clock frequency of 1 MHz by the use of a counter, it is possible to control the rotation speed of the DD motor. In other words, the rotation speed of the DD motor is controlled by starting the counter in synchronism with a leading edge timing of the FG servo signal and comparing a trailing edge timing of the FG servo signal and a trailing edge timing of the frequency-division clock signal which is obtained by counting a fixed value by the counter.

Specifically, if the trailing edge timing of the FG servo signal is earlier than the trailing timing of the frequency-division clock signal, the DD motor is controlled so that the rotation speed is decelerated. On the contrary, if the trailing edge timing of the FG servo signal is later than the trailing edge timing of the frequency-division clock signal, the DD motor is controlled so that the rotation speed is accelerated.

As described above, the existing flexible disk drive requires the printed wiring board 500 in order to form the DD motor. The printed wiring board 50 is disposed on the back surface of the main frame 13. In order to support the weight of the DD motor, the motor frame made of metal like the main frame 13 is required. Electrical connection between the printed wiring board 500 and the main printed wiring board 30 is easily obtained by arranging these boards to be adjacent to each other.

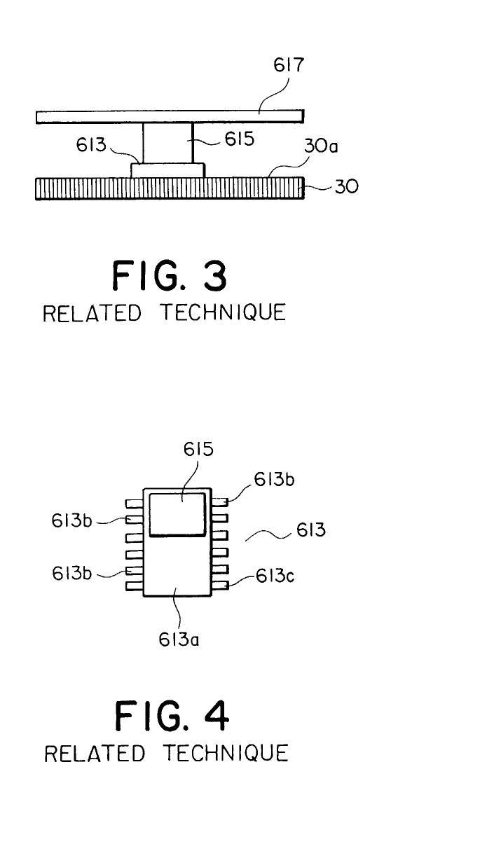

As illustrated in FIGS. 3 and 4, the main printed wiring board 30 is provided with an electronic component 613 mounted thereon. The electronic component 613 requires a large electric current so that self heat of a large quantity is generated. The self heat generated from the electronic component 613 may adversely affect the operation or the function of the flexible disk drive and, therefore, must be released by the use of a heat release structure.

In the existing flexible disk drive with a heat release structure, the electronic component 613 mounted on the main printed wiring board 30 is covered with an iron cover 617 (i.e., a heat release plate) through a heat release member 615. With this heat release structure, the self heat generated from the electronic component is transferred and released through the heat release member 615 to the iron cover 617.

The main printed wiring board 30 has one surface 30a provided with conductive signal patterns and conductive ground patterns, although not shown in the figure. The electronic component 613 comprises an electronic component body 613a, a plurality of conductive signal terminals 613b extending outward from a pair of side surfaces of the electronic component body 613a, and a plurality of conductive ground terminals 613c extending outward from the side surfaces of the electronic component body 613a. The signal terminals 613b are connected to the signal patterns while the ground terminals 613c are connected to the ground patterns.

However, in the existing flexible disk drive with a heat release structure mentioned above, the self heat generated from the electronic component 613 is transferred and released through the heat release member 615 to the iron cover 617. Thus, the heat release member 615 and the iron cover 617 are required in order to release the self heat generated from the electronic component 613. As a consequence, the number of elements of the flexible disk drive is inevitably increased.

Upon assembling the existing flexible disk drive with a heat release structure, the heat release member 615 is formed on the electronic component 613 after the electronic component 613 is mounted on the main printed wiring board 30. Thereafter, the iron cover 617 is arranged on the electronic component 613 through the heat release member 615. Thus, assembling is inevitably complicated.

Now, an embodiment of this invention will be described in detail with reference to the drawing. A flexible disk drive according to the embodiment of this invention is basically similar in structure to the existing flexible disk drive mentioned above. Similar parts are designated by like reference numerals and description thereof will be omitted.

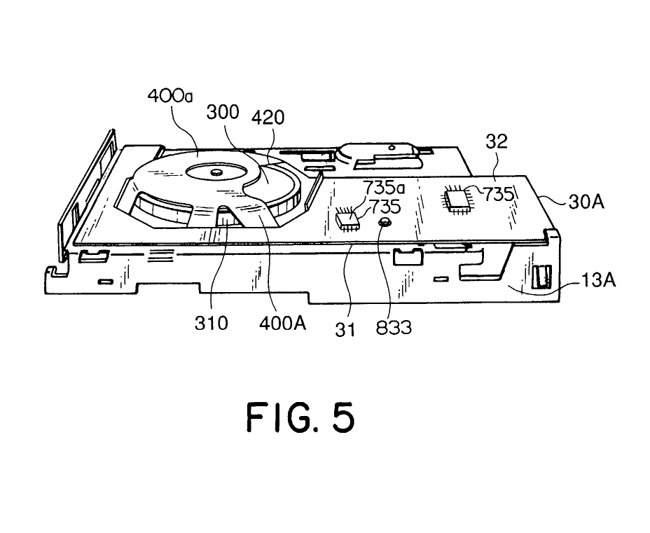

At first referring to FIG. 5, the flexible disk drive is provided with a mechanical structure which is for receiving the flexible disk and comprises a main frame 13A as a particular portion of the mechanical structure. In the figure, the main frame 13A is obliquely seen from the below.

As illustrated in FIG. 5, the main frame 13A adapted to support a flexible disk received in the mechanical structure is a single-piece component with a motor frame part 400A integrally formed. To the motor frame part 400A, a spindle motor 300 for driving and rotating the flexible disk inserted into the main frame 13A is mounted. For example, the main frame 13A is formed by press-punching and then bending a metal plate. Thus, the main frame 13A also serves as a motor frame.

The motor frame part 400A has a drawn shape obtained by drawing in the manner known in the art. The motor frame part 400A protrudes outward from a back surface 13g of the main frame 13A and has a protruding surface 400a at an outermost end thereof. As seen from the side of the back surface 13g, the protruding surface 400a may be called a top surface. The motor frame part 400A is provided with an opening 420 formed in the protruding surface 400a to extract lead wires of the spindle motor 300.

Like in the existing flexible disk drive, a main printed wiring board 30A is attached to the back surface 13g of the main frame 13A. The main printed wiring board 30A has a shape such as not to overlap the motor frame part 400A.

The main printed wiring board 30A has a first surface 31A faced to the back surface 13g of the main frame 13A. The first surface 31 is spaced at a predetermined distance from the back surface 13g of the main frame 13A. The main printed wiring board 30A has a second surface 32 opposite to the first surface 31. The second surface 32 is located at a height lower than that of the protruding surface 400a of the motor frame part 400A with respect to the back surface 13g of the main frame 13A.

The spindle motor 300 mounted to the motor frame part 400A has a stator with coils wound therearound. The coils have end portions as the lead wires which are extracted through the opening 420 formed in the motor frame part 400A to the side of the back surface 13g to be connected and fixed to predetermined terminals (not shown) of the main printed wiring board 30A.

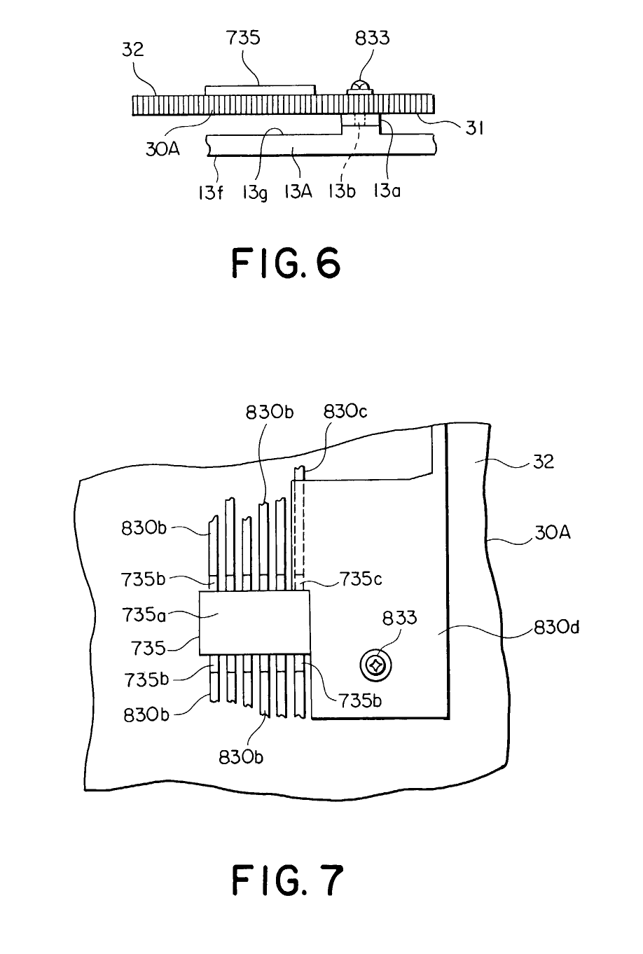

Referring to FIGS. 6 and 7 in addition to FIG. 5, a heat release structure for an electronic part according to this invention will be described in detail. In this embodiment, an electronic component 735 is mounted on the second surface 32 of the main printed wiring board 30A.

The second surface 32 of the main printed wiring board 30A is provided with a plurality of conductive signal patterns 830b and at least one conductive ground pattern 830c which is referred to as a first ground pattern. Each of the signal patterns 830b and the ground pattern 830c comprises a thin film such as a copper foil.

The electronic component 735 comprises an electronic component body 735a, a plurality of conductive signal terminals 735b extending outward from a pair of side surfaces of the electronic component body 735a, and at least one conductive ground terminal 735c extending outward from at least one of the side surfaces of the electronic component body 735a.

The signal terminals 735b are connected to the signal patterns 830b in one-to-one correspondence. The ground terminal 735b is connected to the ground pattern 830c.

The electronic component 735 may be a drive IC, a spindle IC, and so on, as well known in the art. The second surface 32 of the main printed wiring board 30A is provided with a conductive additional ground pattern 830d formed as a second ground pattern in a portion except the signal patterns 830b. Specifically, a region for the additional ground pattern 830d is preliminarily determined on the second surface 32 of the main printed wiring board 30A. In the region, the additional ground pattern 830d is formed.

The ground pattern 830c and the additional ground pattern 830d are connected to each other on the second surface 32 of the main printed wiring board 30A. The additional ground pattern 830d and the main frame 13A are connected to each other through a conductive holding member 833. The additional ground pattern 830d has an area at least greater than that of the ground pattern 830c. The main frame 13A has a frame holding part 13a protruding towards the main printed wiring board 30A.

The frame holding part 13a is formed by cutting and bending a portion of the main frame 13A and has a threaded hole 13b formed at its end. For example, the holding member 833 comprises a metal screw which is engaged with the frame holding part 13a within the region of the additional ground pattern 30d. Thus, the main printed wiring board 30A is held by the holding member 833 with the predetermined distance kept from the back surface 13g of the main frame 13A.

After the electronic component 735 is mounted on the second surface 32 of the main printed wiring board 30A, the signal terminals 735b are connected to the signal patterns 830b by soldering while the ground terminal 735c is connected to the ground pattern 830c by soldering.

Thereafter, the holding member 833 is engaged with the frame holding part 13a of the main frame 13A so that the main printed wiring board 30A and the main frame 13A are integrally held. At this time, the main printed wiring board 30A and the main frame 13A are spaced from each other with a gap defined by the frame holding part 13a.

In the heat release structure mentioned above, the self heat generated in the electronic component body 735a is released by heat transfer through the holding member 833 and the frame holding part 13a to the main frame 13A. Simultaneously, the self heat generated from the electronic component body 735a is released by heat transfer to the additional ground pattern 830d.

With the flexible disk drive as described above, the self heat generated from the electronic component body can be released by heat transfer through the holding member to the main frame. Simultaneously, the self heat generated from the electronic component body can also be released by heat transfer to the additional ground pattern. Therefore, the flexible disk drive is not required to have special additional components, such as a heat release member and a heat release plate (iron cover), for releasing the self heat generated from the electronic component body. It is consequently possible to reduce the number of elements of the flexible disk drive. The printed wiring board is simply held by the holding member on the main frame. Therefore, assembling is easy. In the flexible disk drive, special additional components, such as a heat release member or a heat release plate (iron cover), are not required. Therefore, a mounting space on the main printed wiring board can be reduced or saved. In other words, it is therefore possible to effectively use a space on the main printed wiring board.

It will readily be understood that this invention is not restricted to the above-mentioned embodiment but may be modified in various other manners within a scope defined by the appended claims.

What is claimed is:

1. A flexible disk drive with a heat release structure for driving a flexible disk, comprising:
a mechanical structure for receiving said flexible disk;
a main printed wiring board mounted on said mechanical structure;
a holding member holding a space between said main printed wiring board and said mechanical structure; and
an electronic component mounted on said main printed wiring board,
said electronic component comprising:
an electronic component body;
a conductive signal terminal extending outward from said electronic component body; and
a conductive ground terminal extending outward from said electronic component body,
said main printed wiring board including:
a signal pattern connected to said conductive signal terminal;
a first ground pattern connected to said conductive ground terminal; and
a second ground pattern connected to said first ground pattern and to said mechanical structure through said holding member.

2. The flexible disk drive according to claim 1, wherein said mechanical structure comprises:
a main frame having a principal surface for supporting said flexible disk received in said mechanical structure and having a back surface opposite to said principal surface; and
a motor mounted on said back surface of said main frame for driving said flexible disk supported on said principal surface, said main printed wiring board having a first surface and a second surface opposite to said first surface, said main printed wiring board being attached to said main frame so that said first surface is faced to said back surface of said main frame, said main printed wiring board being provided with a control circuit for controllably driving said motor, said electronic component being mounted on said second surface of said main printed wiring board.

3. The flexible disk drive according to claim 2, wherein said main frame has a motor frame part with said motor mounted thereon, said motor frame part being integral with said main frame.

4. The flexible disk drive according to claim 3, wherein said motor frame part protrudes outward from said back surface of the main frame and has a protruding surface at an outermost end thereof.

5. The flexible disk drive according to claim 4, wherein said second surface of the main printed wiring board is located at a height lower than that of said protruding surface of the motor frame part with respect to said back surface of said main frame.

6. The flexible disk drive according to claim 1, wherein said second ground pattern has an area at least greater than that of said first ground pattern.

7. The flexible disk drive according to claim 1, wherein said main frame has a frame holding part protruding towards said main printed wiring board, said frame holding part and said main printed wiring board being held by said holding member.

8. The flexible disk drive according to claim 7, wherein said holding member holds said frame holding part within a region of said second ground pattern.

9. The flexible disk drive according to claim 8, wherein said holding member comprises a metal screw, said frame holding part being formed by cutting and bending a portion of said main frame to stand up on said back surface, said frame holding part being provided with a threaded hole formed at its end portion to be engaged with said holding member for fixing said main printed wiring board to said main frame.
